(19) United States
(12) Patent Application Publication
(10) Pub. No.: US 2026/0044180 A1
(43) Pub. Date: Feb. 12, 2026

(54) Adjusting Clock Signals based on Machine Learning

(71) Applicant: Stathera IP Holdings Inc., Montreal (CA)

(72) Inventors: George Xereas, Montreal (CA); Reuble Mathew, Saint-Lambert (CA); Animesh Saha Shovan, Montreal (CA)

(21) Appl. No.: 19/293,400

(22) Filed: Aug. 7, 2025

Related U.S. Application Data
(60) Provisional application No. 63/681,461, filed on Aug. 9, 2024.

(51) Int. Cl. G06F 1/08

(52) U.S. Cl. CPC G06F 1/08

(57) ABSTRACT

A system for adjusting a clock signal may include a timing system that receives a reference timing signal having a reference frequency, a plurality of sensors to generate sensor data, an oscillator to generate a clock signal, and one or more processors. The one or more processors may execute instructions stored in memory to train a machine learning model to predict frequency drift of the clock signal based on the sensor data and frequency drifts between an output frequency of the clock signal and the reference frequency. The sensor data may be utilized as training data, and the frequency drifts may be utilized as target data. The one or more processors may further execute to adjust the clock signal to compensate for frequency drift based on a prediction from the model. Other aspects are also described and claimed.

### RELATED APPLICATIONS

This application claims the benefit of priority from U.S. Provisional Patent Application Ser. No. 63/681,461 filed on Aug. 9, 2024, the full disclosure of which is incorporated herein by reference.

### BACKGROUND

### Field

This disclosure relates generally to systems including clock signals and, more specifically, to adjusting clock signals based on machine learning. Other aspects are also described.

### Background Information

Timing devices may be used to enable functionality in many different applications, such as computers, smartphones, and other electronic equipment. Such timing devices traditionally comprise quartz oscillators utilized to generate clock signals for the application.

More recently, silicon oscillators have been used to generate clock signals. Silicon oscillators may include microelectromechanical system (MEMS) devices, which are small integrated devices or systems that combine electrical and mechanical components to generate the clock signals. The components can range in size from the sub-micrometer level to the millimeter level, and there can be any number, from one to a few, to potentially thousands or millions, in a given system.

### SUMMARY

Implementations of this disclosure include utilizing a reference timing signal received by a host system, and sensor data received from multiple sensors of the host system and/or a clock system, to train a machine learning model, in situ with the host system, to predict frequency drifts of clock signals being utilized by the host system. The frequency drifts can then be corrected based on predictions that may be generated when the reference timing signal is unavailable (e.g., during a lower power mode or network connection loss, including unavailability of a network connection due to unintentional or intentional interference).

The machine learning model, which may include a trained neural network, may provide an improvement over conventional systems, including those utilizing fixed polynomial coefficients determined during factory calibration. The machine learning model may be progressively trained in the system over time to learn complex, non-linear relationships between multiple sensors providing sensor data, and/or two modes of vibrations of a resonator, to predict frequency drifts or errors to be corrected or adjusted. The training may be based on, and may compensate for, effects in the system that are not present or captured during calibration, such as sensing packaging stress, increasing temperature, DC bias voltage, etc., while the system is utilized to provide timing for another system in the field. Thus, adjusting a clock signal based on a machine learning model that is configured and trained as described herein provides an accuracy improvement over past systems, including those utilizing polynomial models.

In some implementations, a system for adjusting a clock signal may include a timing system that receives a reference timing signal having a reference frequency, a plurality of sensors to generate sensor data, an oscillator to generate a clock signal, and one or more processors. The one or more processors may execute instructions stored in memory to train a machine learning model, during a training period, to predict frequency drift of the clock signal based on the sensor data and frequency drifts between an output frequency of the clock signal and the reference frequency. The sensor data may be utilized as training data to train the machine learning model, and the frequency drifts may be utilized as target data representing a correct output to predict, during the training period. The one or more processors may further execute to adjust the clock signal, during a deployment period, to compensate for frequency drift based on a prediction from the machine learning model when the reference timing signal is unavailable.

In some implementations, a method for adjusting a clock signal may include receiving a reference timing signal having a reference frequency; receiving sensor data from a plurality of sensors; training a machine learning model, during a training period, to predict frequency drift of a clock signal based on the sensor data and frequency drifts between an output frequency of the clock signal and the reference frequency; and adjusting the clock signal, during a deployment period, to compensate for frequency drift based on a prediction from the machine learning model when the reference timing signal is unavailable. The sensor data may be utilized as training data to train the machine learning model, and the frequency drifts may be utilized as target data representing a correct output to predict, during the training period. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system that adjusts clock signals based on machine learning.

FIG. 2A is an example of a first portion of a process for adjusting clock signals based on machine learning, and FIG. 2B is an example of a second portion of the process.

FIG. 3 is a first example of adjusting a clock signal in a host system.

FIG. 4 is a second example of adjusting a clock signal in a host system.

FIG. 5 is a block diagram of an example internal configuration of a host system for adjusting clock signals based on machine learning.

FIG. 6 is another example of a process for adjusting clock signals based on machine learning.

FIG. 7A is an example of a dual mode MEMS resonator operating in an out-of-plane mode of vibration to produce a first clock signal; and FIG. 7B is an example of the same dual mode MEMS resonator operating in an in-plane mode of vibration to produce a second clock signal.

FIG. 8A is an example of a dual mode MEMS resonator operating in a first in-plane mode of vibration to produce a first clock signal; and FIG. 8B is an example of the same dual mode MEMS resonator operating in a second in-plane mode of vibration to produce a second clock signal, one in the kHz range, the other in the MHz range.

FIG. 9A is an example of a dual mode MEMS resonator operating in a first in-plane mode of vibration to produce a first clock signal; and FIG. 9B is an example of the same dual mode MEMS resonator operating in a second in-plane mode of vibration to produce a second clock signal, both in the MHz range.

FIG. 10 is an example of signal processing for a temperature sensing circuit that utilizes a dual mode resonator having in-plane and out-of-plane resonant modes and a beat frequency to provide temperature sensing used to train a machine learning model.

FIG. 11 is a first example of a machine learning model to adjust clock signals.

FIG. 12 is a second example of a machine learning model to adjust clock.

### DETAILED DESCRIPTION

Traditional timing devices, such as quartz oscillators, may suffer from several limitations that can affect accuracy, power efficiency, and/or adaptability, particularly in demanding applications such as smartphones, navigation systems, and telecommunications. These timing devices may be sensitive to fluctuations in their environments resulting in frequency drifts of clocks that degrade performance over time. Further, long-term aging of the devices can introduce permanent changes that also reduce accuracy.

For example, traditional timing devices may suffer from limitations including accuracy degradations where clock frequencies drift over time due to aging and/or environmental changes. This can lead to a gradual loss of accuracy, which may be problematic in applications where a higher degree of timekeeping may be important. They may also suffer from environmental sensitivities, such as variations in temperature, humidity, and other environmental conditions, which may adversely impact performance. They may also suffer from high power consumption in order to achieve higher accuracy, which can make these timing devices difficult to implement in battery-operated applications such as mobile devices (e.g., smartphones, laptops, and tablets) and Internet of Things (IoT) devices (e.g., wearable devices, such as smart glasses). They may also lack adaptability to changing environmental conditions, making them unable to self-correct for deviations caused by factors such as mechanical shock, vibration, and/or electromagnetic interference (EMI). They may also have limited longevity, with the aging of these devices leading to permanent shifts in frequency, and reductions in lifespan, and reliability.

Implementations of this disclosure address problems such as these by utilizing a reference timing signal received by a host system, and sensor data received from multiple sensors of the host system and/or a clock system (e.g., environmental data), to train a machine learning model, in situ with the host system, to predict frequency drifts of clock signals being utilized by the host system. The frequency drifts can then be corrected based on predictions that may be generated when the reference timing signal is unavailable (e.g., during a lower power mode or a network connection loss, including unavailability of network connection due to unintentional or intentional interference).

The machine learning model, which may include a trained neural network, may provide an improvement over conventional systems, including those utilizing fixed polynomial coefficients determined during factory calibration. The machine learning model may be progressively trained in the system over time to learn complex, non-linear relationships between multiple sensors providing sensor data, and/or two modes of vibrations of a resonator, to predict frequency drifts or errors to be corrected or adjusted. The training may be based on, and may compensate for, effects in the system that are not present or captured during calibration, such as sensing packaging stress, increasing temperature, DC bias voltage, etc., while the system is utilized to provide timing for another system in the field. Thus, adjusting a clock signal based on a machine learning model that is configured and trained as described herein provides an accuracy improvement over past systems, including those utilizing polynomial models.

Some implementations may include a system that includes a timing system, a plurality of sensors, an oscillator, and one or more processors. The timing system can receive a reference timing signal having a reference frequency, such as a pulse per second (PPS, or 1 PPS) signal from a global navigation satellite system (GNSS), a cellular network, or an Ethernet network. The plurality of sensors can generate sensor data characterizing the system, such as a temperature, humidity, acceleration, rotation, vibration, strain, pressure, and/or magnetic field of the system. The sensors may include host system sensors and/or clock system sensors, and may collect sensor data indicating steady state conditions (including on different timescales) and/or transient conditions.

The oscillator can generate one or more clock signals. The oscillator may be a quartz oscillator or a silicon oscillator, such as a MEMS device. The one or more processors may include general processors and/or dedicated machine learning (ML) or artificial intelligence (AI) processors, which may be implemented by the clock system, by the host system that implements the clock system to receive the one or more clock signals, or a combination of both. The one or more processors can execute instructions stored in memory to train a machine learning model, during a training period, to predict a frequency drifts of the clock signal based on a combination of the sensor data and frequency drifts or errors, e.g., determined between an output frequency of the clock signal and the reference frequency. The sensor data may be utilized as training data to train the machine learning model, and the frequency drifts or errors may be utilized as target data representing a correct output that the machine learning model should predict, during the training period. The one or more processors may further execute to adjust the clock signal, during a deployment period, to compensate for the frequency drift based on a prediction from the machine learning model. For example, the clock signal can be adjusted based on the prediction from the machine learning model when the reference timing signal is unavailable (e.g., the lower power mode or network connection loss).

As a result, the system can mitigate one or more limitations of traditional timing devices, such as by correcting for long term aging behavior and/or compensating for environmental conditions. The system can therefore maintain high precision and reliability over relatively longer periods, adapt to environmental changes, and/or operate more efficiently in power-sensitive applications.

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

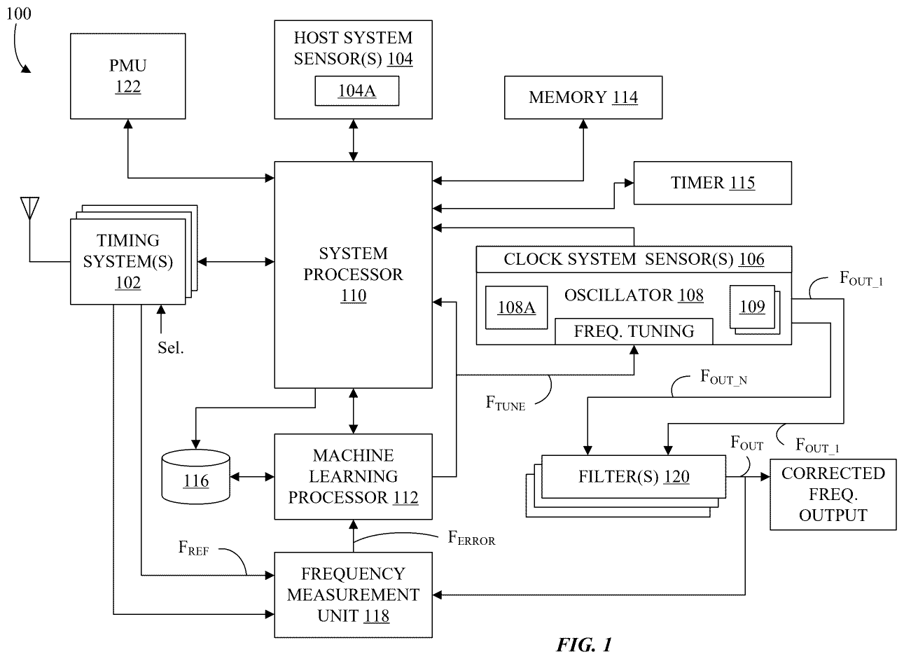

FIG. 1 is an example of a system 100 that adjusts clock signals based on machine learning. The system 100 may utilize a modular architecture to include components of a clock system and/or components of a host system that implements the clock system as described herein. In particular, the system 100 may include one or more timing systems selectable by a select input, such as timing system 102, a plurality of sensors, including host system sensors 104 and/or clock system sensors 106, an oscillator 108, and one or more processors, such as a system processor 110 and/or a machine learning processor 112. The system 100 may also include a memory 114 (e.g., storing sensor data and frequency drifts or errors), a data structure 116 (e.g., storing training data, target data, and an updateable machine learning model), a frequency measurement unit 118, a filter 120, and/or a PMU 122 (power management unit). The system 100 can utilize the oscillator 108 to generate one or more clock signals, each having a given output frequency, such as a clock signal having an output frequency F_{OUT}. The system 100 can generate the one or more clock signals for the host system to utilize, such as a mobile device, navigation system, telecommunication system, wearable device, automotive system, or other electronic equipment.

In the system 100, the timing system 102 selected can receive a reference timing signal having a reference frequency, such as F_{REF} (e.g., an accurate timing reference). For example, the reference timing signal could be a PPS or 1 PPS signal (1 Hz). The timing system 102 can receive the reference timing signal from a GNSS (e.g., GPS, GLONASS, Galileo, or BeiDou), a cellular network (e.g., a 5G or 6G network), or an Ethernet network (e.g., Wi-Fi), via a wired or wireless connection. In some cases, the timing system can receive a plurality of reference timing signals, each having a respective reference frequency. For example, the timing system could receive a first reference timing signal having a higher frequency (e.g., a cellular network), and a second reference timing signal having a lower frequency (e.g., GNSS). In another example, the timing system could receive a first reference timing signal having a first reference frequency (e.g., 1 PPS) from a first timing source (e.g., GNSS), a second reference timing signal having a second reference frequency from a second source (e.g., a cellular network), and/or a third reference timing signal having a third reference frequency from a third source (e.g., an Ethernet network). The timing system 102 could be implemented as a component of the host system. The timing system 102 can provide the reference timing signal to the frequency measurement unit 118 for determining frequency drifts or errors (F_{ERROR}) between an output frequency of the clock signal (F_{OUT}) and the reference frequency (F_{REF}).

In some cases, the system processor 110 may communicate with and control the timing system 102 and/or a timer 115. The timer 115, which may include a real time clock (RTC) or other timing device, may be utilized for measuring a total time since deployment of the system 100 (e.g., elapsed time, measured in minutes, hours, days, etc.). The measured time can then be input to the machine learning model to perform training and/or to generate predictions. For example, the measured time may enable the model to account for long-term drifts in a way that might not be captured by the sensor data. In some cases, a reference timing signal may be selected and utilized depending on the timescale to be utilized by the system 100. For example, a 1 PPS signal from GPS could be used to provide corrections at a minimum time interval of 1 second. However, in some cases it may not be desirable to provide frequency error corrections at this time interval, for example if the Allan Deviation of the 1 PPS signal is worse than that of the clock signal being compared (F_{OUT}) at different time scales. A temperature-compensated crystal oscillator (TCXO) may have better stability than the 1 PPS signal when averaged for less than 100 seconds, whereas an oven-controlled crystal oscillator (OCXO) may have better stability when averaged for less than 1000 seconds. Therefore, it may be preferable to use the 1 PPS signal to correct the OCXO on timescales that are longer than 1000s of seconds. The system 100 can determine the stability of the reference timing signal with respect to the clock signal to determine the interval at which the frequency adjustment or correction occurs. In some cases, the timing system 102 may receive two or more reference timing signals with each having a respective reference frequency, and the timing system 102 may further select a particular reference timing signal depending on the timescale to be utilized by the system 100.

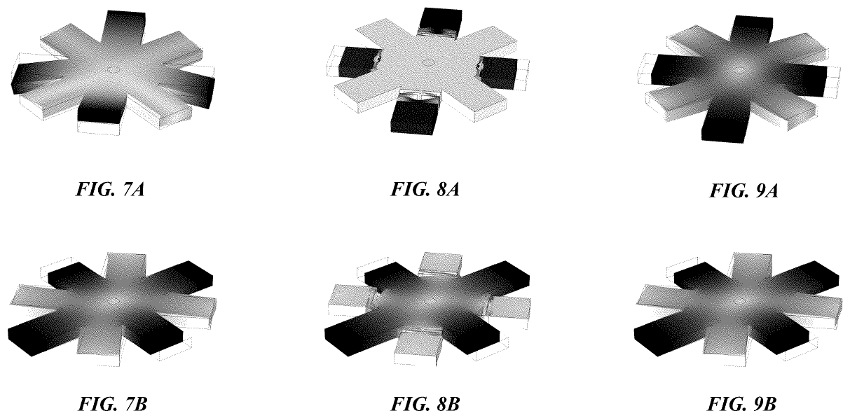

The present inventors have recognized that certain configured clock signal in the system 100 (each of which may be compared to a reference timing signals) may further improve training of the machine learning model so that further accuracy of predictions may be achieved over time. The oscillator 108 can utilize one or more resonant elements or resonators to generate one or more clock signals to provide such output timing for the host system. The oscillator 108 could be a quartz oscillator or a silicon oscillator, such as a MEMS device. In some cases, the oscillator 108 may include one or more dual mode MEMS resonators, such as a dual mode MEMS resonator 109, which may be implemented by an application-specific integrated circuit (ASIC).FIGS. 7-9 illustrate possible operations of the dual mode MEMS resonator 109. Specifically, the dual mode MEMS resonator 109 can be selectively operated in one of various modes, such as 1) an out-of-plane mode of vibration (e.g., FIG. 7A, producing a first clock signal in the kHz range) operating concurrently with an in-plane mode of vibration (e.g., FIG. 7B, producing a second clock signal in the MHz range); 2) a first in-plane mode of vibration (e.g., FIG. 8A, producing a first clock signal in the kHz range) operating concurrently with a second in-plane mode of vibration (e.g., FIG. 8B, producing a second clock signal in the MHz range); or 3) a first in-plane mode of vibration (e.g., FIG. 9A, producing a first clock signal in the MHz range) operating concurrently with a second in-plane mode of vibration (e.g., FIG. 9B, producing a second clock signal in the MHz range, the second clock having a different frequency than the first clock signal). Further, in some cases, one of the clock signals (e.g., the first clock signal of a selected mode) may be configured to be temperature-sensitive, while the other of the clock signals (e.g., the second clock signal of the selected mode) may be configured to be temperature-insensitive, or temperature-stable. This may enable an internal self-referencing in which one mode may perform as a co-located temperature sensor for the other.

A selected in-plane mode may be in the MHz range, and a selected out-of-plane mode may be in the kHz range. A selected in-plane mode may be a Lamé mode of vibration of the resonator, and a selected out-of-plane mode may be a saddle mode of vibration of the resonator. As a result, multiple combinations of in-plane modes and/or out-of-plane modes of vibration of the resonator are possible in the system 100, such as two in-plane modes, two out-of-plane modes, or one in-plane mode and one out-of-plane mode. In some cases, two in-planes may be selected to reduce sensitivity to packaging stress. In some cases, the two modes may be selected to produce clock signals that are close in frequency to one another, e.g., a same order of magnitude, within 20% of one another. This may help to optimize the phase noise of the clock.

Further, the oscillator 108 may include a plurality of resonators, one or more of which may be like the dual mode MEMS resonator 109. That is, the oscillator 108 may include X number of resonators where X is an integer greater than one. For example, the oscillator 108 may include a first dual mode MEMS resonator producing a first clock signal based on an out-of-plane mode of vibration (FIG. 7A) and a second clock signal based on an in-plane mode of vibration (FIG. 7B); a second dual mode MEMS resonator producing a third clock signal based on a first in-plane mode of vibration (FIG. 8A) and fourth clock signal based on a second in-plane mode of vibration (FIG. 8B); and a third dual mode MEMS resonator producing a fifth clock signal based on a first in-plane mode of vibration (FIG. 9A) and a sixth clock signal based on a second in-plane mode of vibration (FIG. 9B). The multiple clocks signals produced in this way may accurately enable further training data for the machine learning model. For example, the first resonator may have increased stress sensitivity, the second resonator may have increased temperature sensitivity, and these two (the first and second resonators) may be adjacent to a primary resonator (a third resonator) with a predicted drift control utilized to control timing in the system. The oscillator 108, in turn, may produce two electrical signals, including a first electrical signal having a first frequency, e.g., a first clock signal F_{OUT_1}, and a second electrical signal having a second frequency, e.g., a second clock signal F_{OUT_2}, utilizing the dual mode MEMS resonator 109.

In some embodiments, the first and second electrical signals may be mixed to obtain a third electrical signal having a third frequency, where the third frequency is proportional to a temperature of the MEMS resonator. The temperature may be determined based on the third frequency. Values of the first and second frequencies can be adjusted based on the determined temperature to compensate for frequency deviations due to temperature deviations. Including the dual mode MEMS resonator 109 (with in-plane and out-of-plane modes) may enable direct temperature sensing at the core of the resonator, reducing thermal lag and improving correction accuracy. Further, the mode frequencies may be closely spaced or significantly separated, offering flexibility in compensation. As a result, the temperature (measured directly at the resonator) may be derived from the dual-output of the dual mode MEMS resonator 109 for adjusting the frequency drift, including by utilizing the machine learning model to predict and/or adjust based on the dual-mode, measured temperature.

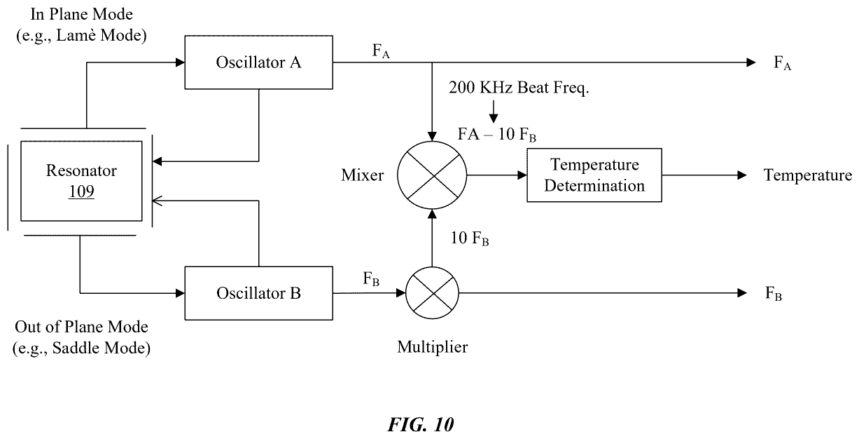

In some embodiments, the oscillator 108 may operate as described in U.S. Pat. No. 11,305,981, titled “Dual-output microelectromechanical resonator and method of manufacture and operation thereof,” assigned to Stathera IP Holdings Inc. FIG. 10 is an example of a signal processing architecture for a temperature sensing circuit that utilizes a dual mode resonator (e.g., the dual mode MEMS resonator 109) having in-plane (F_{A}) and out-of-plane (F_{B}) resonant modes and a beat frequency (F_{A}−10F_{B}) which provides temperature data (e.g., a sensed temperature of the sensor data). This is a demonstration of dual-mode temperature compensation using fixed polynomial relationships. This approach may be enhanced using a machine learning model as described herein. Specifically, the machine learning model, which may include a trained neural network, may provide an improvement over conventional systems, such as those utilizing fixed polynomial coefficients determined during factory calibration. The machine learning model may be progressively trained in the system over time to learn complex, non-linear relationships between multiple sensors providing sensor data, and/or two modes of vibrations, to predict and correct frequency drifts or errors. This training may be based on, and compensate for, effects in the system that are not present or captured during calibration, such as packaging stress, increasing temperature, DC bias voltage, etc. Thus, adjusting a clock signal to compensate for a frequency drift based on a prediction from the machine learning model as described herein provides an accuracy improvement over past systems, including those utilizing polynomial models.

For example, conventional systems may utilize a traditional approach that relies on fixed polynomial coefficients determined during factory calibration. In contrast, training the machine learning model to predict frequency drift of a clock signal as described herein enables capture of more complex relationships. When multiple factors affect the frequency output, such as packaging stress, increasing temperature, DC bias voltage, etc., a fixed polynomial model of a conventional system will be unable to accurately predict the frequency drift. However, the machine learning model described herein may be trained to predict based on the complex, dynamic relationships between output frequency and changing environmental conditions indicated by the sensor data, including incorporating both short-term and long-term behavioral patterns that cannot be captured by fixed polynomial modelling. This represents an improved approach to compensation of the clock signal to correct frequency drifts or errors.

Referring back to the polynomial model example of FIG. 10, this is an example of system that may be useful for providing temperature data as sensor data to the machine learning model, and may be improved upon for correcting frequency drifts or errors by the machine learning model as described herein. The system includes a first oscillation circuit or oscillator A electrically connected to a MEMS resonator, and a second oscillation circuit or oscillator B also electrically connected to the MEMS resonator. The system also includes power supply components to provide alternating current (AC) and/or DC (direct current) electrical signals for causing the MEMS resonator to resonate in the in-plane mode of vibration and the out-of-plane mode of vibration. Oscillator A is configured for operating the resonator in an in-plane mode of vibration such as a Lamé mode of vibration or a face-shear mode of vibration, in order to obtain a first electrical signal having a first frequency F_{A}. For example, Oscillator A may comprise a transimpedance amplifier (TIA) connected to an automatic gain control (AGC). The TIA may convert the current from the resonator to an output signal. The AGC regulates oscillation amplitude and reduces mechanical non-linear effects. Oscillator B is configured for operating the resonator in an out-of-plane mode of vibration such as a second harmonic mode of vibration or a saddle mode of vibration in order to obtain a second electrical signal having a second frequency F_{B}. Similarly, oscillator B may comprise a TIA connected to an AGC. The TIA converts the current from the resonator to an output signal. The AGC regulates oscillation amplitude and reduces mechanical non-linear effects. The resonator with oscillator A and oscillator B may form the dual mode MEMS resonator 109.

The system also includes a multiplier, e.g., frequency multiplier circuit, electrically connected to the oscillator B for receiving the second electrical signal. The multiplier may be a nonlinear electrical circuit that distorts an input signal thereby generating harmonics or multiples of the input signal. The multiplier receives the second electrical signal having the second frequency F_{B} and multiplies the second frequency F_{B} by a given factor to output a third electrical signal. The multiplier is configured for multiplying the frequency F_{B} by a multiplier, e.g., 10. As a result, the multiplier outputs the third electrical signal of which the frequency corresponds to the second frequency F_{B} multiplied by a given factor, such as 10 times the second frequency F_{B}.

The system also includes a mixer and a temperature determination circuit. The mixer is electrically connected to oscillator A for receiving the first electrical signal, and to the multiplier for receiving the third electrical signal. The mixer, also known as frequency mixer, is a nonlinear electrical circuit that generates a frequency based on two electrical signals. The mixer is configured for generating a fourth electrical signal of which a frequency F_{BEAT} corresponds to the frequency of the first electrical signal, minus the frequency of the fourth electrical signal, i.e., F_{A} minus 10×F_{B}. The mixer may be adapted to output an electrical signal of which the frequency F_{BEAT} corresponds to the first frequency F_{A} divided by 10×F_{B}. The temperature determination circuit is electrically connected to the mixer to receive the fourth electrical signal. The temperature determination circuit is configured to process the fourth electrical signal outputted by the mixer to output an electrical signal indicative of a temperature of the resonator, e.g., the dual mode MEMS resonator 109. The temperature determination circuit may apply a high-order polynomial function and a low-pass filter (LPF) to the received fourth electrical signal. The high-order polynomial function is configured for extracting the temperature of the resonator from F_{BEAT}, and the LPF is configured for filtering the signal coming from the high-order polynomial function as a non-limiting example by blocking all frequencies greater than F_{BEAT}. Coefficients of the high-order polynomial function may be determined during temperature calibration of the resonator, where the resonator is characterized at different temperatures.

Thus, in various implementations, the oscillator 108 may include (i) one or more resonators, each to generate a clock signal, or (ii) one or more resonators, wherein at least one resonator, e.g., the dual mode MEMS resonator 109, generates two or more clock signals. The ASIC may include circuitry to implement a feedback loop for generating the clock signal. For example, the oscillator 108 may include the dual mode MEMS resonator 109 that can generate a clock signal and indicate a temperature when sensing (e.g., one mode functions as a temperature sensor, providing temperature monitoring capabilities, and another mode functions as a passively temperature compensated mode for clock generation). The oscillator 108 can transmit each clock signal to the filter 120.

Referring back to FIG. 1, the filter 120 may perform adaptive filtering to filter out noise and transient variations from each clock signal (e.g., to improve frequency measurements performed by the frequency measurement unit 118). While one filter is shown by way of example, it should be appreciated that multiple filters may be present, in parallel (e.g., N filters, one for each clock signal) and/or series (e.g., Y filters, each applying to a clock signal). For example, to compensate for lower drifts in frequency, e.g., due to aging, a first filter can remove faster variations using a low pass filter and pass a first filtered clock signal to the frequency measurement unit 118. To compensate for higher drifts in frequency and/or faster fluctuations, a second filter (e.g., in parallel with the first filter) can remove slower variations using a high pass filter and pass a second filtered clock signal to the frequency measurement unit 118. Each filter may be selectively enabled or disabled and/or used concurrently with another filter.

The filter 120, in turn, can output each filtered clock signal to the host system, and back to the system 100 to provide feedback. For example, the oscillator 108, via the filter 120, can provide a clock signal having the output frequency (F_{OUT}, generated from F_{OUT_N}) to the host system to use (e.g., a mobile device, such as a smartphone, laptop, or tablet) and back to the frequency measurement unit 118 of the clock system for determining frequency drifts or errors (F_{ERROR}) between the output frequency (F_{OUT}) and the reference frequency (F_{REF}), e.g., utilizing a frequency division of the clock signal to match the clock signal to a frequency of the reference timing signal. The frequency measurement unit 118 can measure the frequency of the oscillator 108 against the frequency of the reference timing signal (e.g., the PPS or 1 PPS signal) to provide real time feedback of frequency drift of the clock signal to the machine learning processor 112 (e.g., for training and/or utilizing the machine learning model).

The plurality of sensors can generate sensor data characterizing the host system and/or the clock system. For example, the sensors can generate sensor data characterizing temperature, humidity, acceleration, rotation, vibration, strain, pressure, and/or magnetic field. In some cases, the sensor data may indicate sensed steady state conditions. For example, the sensor data may indicate continuous updates of temperature, humidity, acceleration, rotation, vibration, strain, pressure, and/or magnetic field, sampled on a periodic basis, as reported from the host system, the clock system, or both. In some cases, the sensor data may indicate sensed data on different timescales. For example, some sensors may provide more frequent sampling (e.g., a temperature sensor reporting a sensed temperature every 10 milliseconds) while other sensors may provide less frequent sampling (e.g., an accelerometer reporting a sensed motion one time per second). In some cases, the sensor data may indicate sensed transient conditions exceeding a threshold. For example, the sensor data may indicate a voltage spike on a power supply line to the host system or the clock system. In another example, the sensor data may indicate a momentary shock or vibration when sensed condition exceeds a threshold (e.g., corresponding to the host system (e.g., mobile device) being dropped). Thus, the plurality of sensors can collect comprehensive environmental and stress/strain data experienced by the host system and/or the clock system.

The plurality of sensors may include host system sensors 104 and/or clock system sensors 106. The host system sensors 104 may include one or more sensors that are native to the host system, such as a temperature, humidity, acceleration, rotation, vibration, strain, pressure, and/or magnetic field sensor. The clock system sensors 106 may include one or more sensors that are integrated with circuitry of the clock system, such as a temperature, bias voltage, strain, electrostatic gap, accelerometer, gyroscope, oscillator drive voltage, MEMS output current, oscillator phase, or internal cavity pressure sensor. In some cases, the clock system sensors 106 may include a temperature sensor of the dual mode MEMS resonator 109 of the oscillator 108, e.g., having a dual mode MEMS die. In some cases, the clock system sensors 106 may include sensors that characterize resonant elements generating the clock signals, such as the temperature of those resonant elements. For example, in some implementations, a clock system sensor can be used to sense and characterize a second resonant element adjacent to a first resonant element that generates the clock signal (F_{OUT}). In some implementations, a neural network input layer of the machine learning model can collect the sensor data from one or more sensors that are adjacent to the clock or built into the MEMS and ASIC devices.

In one example, for a temperature sensor, the resonance frequency of the MEMS device may be sensitive to temperature via a temperature-dependent modulus of elasticity or coefficient of expansion, such that,

$$Δ f = {\sum }_{k = 0}^{N} {TCF}_{k} \times {( T - {T}_{ref} )}^{k} .$$

The MEMS device may be designed to be temperature-compensated, such that the total shift over the operating temperature range is reduced. Measurements of the temperature and knowledge of the coefficients TCFₖ may enable compensation of temperature-sensitivity of the output frequency. In some cases, the ambient temperature may also produce packaging-induced frequency drifts. In some implementations, a temperature sensor can be implemented on the ASIC, using, for example, a pair of bipolar junction transistors (BJT). In some implementations, a second vibrational mode of a MEMS resonator may be utilized. This secondary mode may be designed to be temperature sensitive and the frequency ratio between the two modes can be used to measure and compensate for temperature changes. In some implementations, a second MEMS resonator that is temperature sensitive may be utilized. This resonator can be fabricated in the same die, adjacent to the primary resonator to improve thermal coupling. The output of the temperature sensor could be provided as an input to the machine learning model.

In another example, for a bias voltage sensor, a capacitive MEMS device may utilize a DC bias voltage, V_dc, to operate. The resonance frequency may be sensitive to the bias voltage via an electrostatic force, so changes to the bias voltage due would change the frequency. Short- and medium-term fluctuations may be due to noise in the biasing circuitry. Long-term shifts due to aging of the charge pump that generates V_dc may produce frequency aging. The frequency shift occurs because a change in V_dc produces a shift in the linear spring constant of the MEMS resonator. The dependence on the DC bias voltage, V_dc, may be given by, f(\vec{a})=f₀(1+βV_{dc}²) where for a parallel plate transduction gap, β is a proportionality constant that depends on the electrode area A, the linear mechanical spring constant k_ml, and the electrode transduction gap d_0 to the third power. The bias voltage could be provided as an input to the machine learning model.

In another example, for a strain gauge sensor, a compressive or tensile stress applied to the MEMS die can cause it to bend. However, because the resonator proof mass is suspended above the substrate, it may not bend in the same manner. The resulting change in transduction gap d_0 between the resonator and the drive and sense electrodes may produce a frequency shift via a change in electrostatic force on the resonator. In addition, deformation of the MEMS die may produce mechanical stress near anchor points that translate into a frequency shift. The strain gauge may be implemented using metal film strain gauge fabricated on the MEMS die, or alternatively may be implemented using a second MEMS device designed to serve as a strain sensor. This strain sensor may be fabricated within the same die as the primary MEMS resonator. In some implementations, a strain sensor may be soldered to a common printed circuit board (PCB), for example, to measure the time-varying strain and use it as an input to the machine learning processor 112. The measured strain could be provided as an input to the machine learning model.

In another example, for an electrostatic gap sensor, in addition to a strain gauge, the system 100 may also include a sensor to measure electrostatic gap. For example, a MEMS resonator could be designed with a large β value for enhanced sensitivity to the gap. Varying the DC bias V_dc can then enable a direct measurement of a transduction gap d_0. The gap sensor could be provided as an input to the machine learning model.

In another example, for an accelerometer or gyroscope sensor, the resonant frequency of the MEMS device may have some linear acceleration and rotation sensitivity, given by, f(\vec{a})=f₀(1+\vec{Γ}·\vec{a}), where f_0 is the frequency in the absence of accelerations, \vec{Γₐ} is the acceleration sensitivity vector, and \vec{a} is the acceleration vector. Accelerations due to vibrations may result in frequency deviations and noise. The acceleration sensitivity may stem from an acceleration-induced stress effect due to inertial forces acting on the suspended resonator body, generating stress near anchor points. There may also be acceleration-induced changes to spring softening, wherein movement of the resonator reduces/increases one or more electrostatic transduction gaps. This can change the resonant frequency through the mechanism described for bias voltage sensitivity. While the equation utilizes a linear sensitivity, in some cases an equation may utilize a non-linear relationship, including for the case of spring softening. The system 100 may include a 3-axis accelerometer, soldered to the common PCB, for example, to measure the time-varying acceleration and use it as an input to the machine learning model.

In another example, for an oscillator drive voltage sensor, the MEMS resonator may be actuated with a drive voltage generated by the oscillator 108. If the resulting vibrational amplitude is large, non-linearities may couple the amplitude to the frequency, such that, Δf=χx₀² where x_0 is the displacement amplitude, χ is a proportionality constant that depends on the linear and nonlinear mechanical spring constants, and a nonlinear electrical spring constant that depends on the electrode area A, the DC bias voltage V_dc, and the transduction gap d_0 to the sixth power. Therefore, an oscillator drive voltage sensor (e.g., a clock system sensor 106) could measure a drive voltage to obtain sensor data for input to the machine learning model.

In another example, for a MEMS output current sensor, the output current of the MEMS resonator can depend on a number of parameters, such as drive voltage, bias voltage, oscillator circuit phase, transduction gap, quality factor, and/or temperature. Therefore, the output current can be input to the machine learning model.

In another example, for an oscillator phase sensor, the MEMS resonator can reach stable oscillations when the oscillator 108 circuit satisfies Barkhausen stability conditions for oscillation, such as (i) the loop gain is unity, and (ii) the phase around the loop is an integer multiple of 2π. If the phase between the input and output of the oscillator 108 drifts over time due to aging, temperature, or stress-induced shifts in the properties of the electrical components, then MEMS device may begin to oscillate at a different input-to-output phase, corresponding to a different vibrational frequency, such that Barkhausen conditions may be satisfied. Therefore, the system 100 can utilize an oscillator phase sensor (e.g., a clock system sensor 106) to measure a phase difference between input and output signals of the oscillator 108. The phase can be input to the machine learning model.

In another example, for an internal cavity pressure sensor, the MEMS resonator may be hermetically packaged at low pressure (˜10 mbar) to reduce energy loss due to shear and compressive forces exerted by air particles on the resonator. A change in the damping of the resonator can produce frequency drifts. Therefore, a pressure sensor that is internal to the resonator cavity (e.g., a clock system sensor 106) may be input to the machine learning model.

In another example, for an external pressure, temperature, and/or humidity pressure sensor, the sensor can measure the ambient pressure and humidity external to the MEMS device. These parameters may affect the MEMS device, for example, via changes to the package or the ASIC. For example, for the oscillator 108, variations in the external temperature may affect the dynamics of the feedback loop used to control temperature and may therefore affect the frequency. These environmental parameters may be input to the machine learning model.

In the system 100, the one or more processors may include the system processor 110 and/or the machine learning processor 112. The one or more processors could be implemented, for example, by one or more of a microcontroller, system on a chip (SoC), field programmable gate array (FPGA), and/or ASIC. The system processor 110 may be general processor of the host system or the clock system. The system processor 110 can aggregate sensor data from the plurality of sensors, timing data from the timing system 102, and frequency measurements from the frequency measurement unit 118, and in some cases, control operation of one or more sensors, the timing system 102, and/or the PMU 122. The system processor 110 can also execute control commands from the machine learning processor 112.

The machine learning processor 112 could be a dedicated ML or AI processor of the host system or the clock system (e.g., optimized to perform training and generate predictions). The machine learning processor 112 can utilize the sensor data and the frequency drifts or errors to train the machine learning model and utilize the machine learning model to perform predictive adjustments and dynamic compensation of the clock signal (e.g., output adjustments to control parameters of the oscillator 108). In some cases, the one or more processors may be a single processor that combines functions of the system processor 110 and the machine learning processor 112. The one or more processors may execute instructions stored in memory, such as the memory 114. In some implementations, the system processor 110 and/or the machine learning processor 112 may be native to the host system.

The PMU 122 may provide power to the system 100. The PMU 122 may also be controlled by the one or more processors to enable different power consumption states, such as a higher power mode and a lower power mode. For example, the higher power mode may include enabling the timing system 102 and utilizing it to adjust clock signals for frequency drifts, and the lower power mode may include disabling the timing system 102 and utilizing a machine learning model to adjust the clock signals for frequency drifts based on predictions.

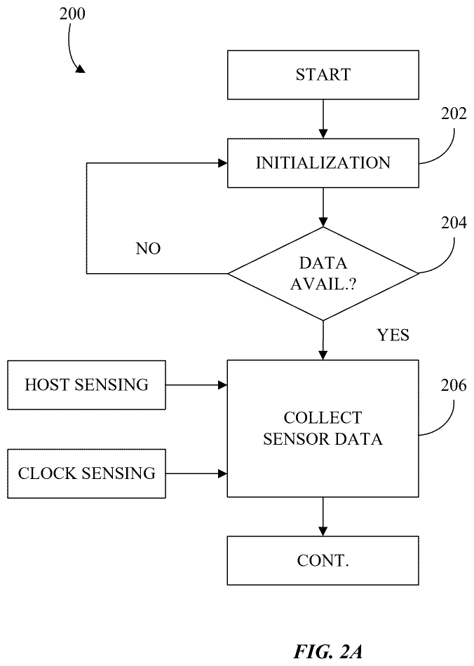

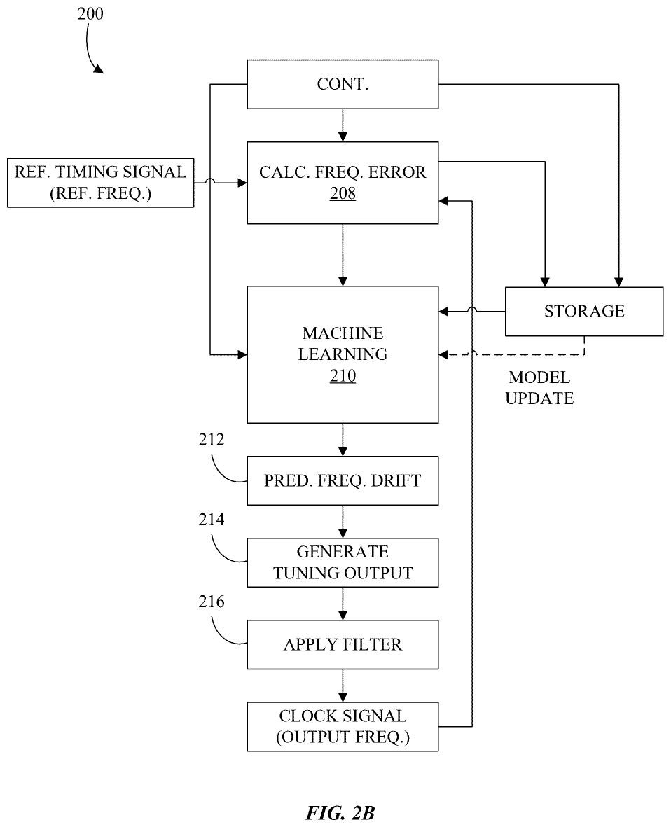

With additional reference to FIG. 2A and FIG. 2B, a process 200 for adjusting clock signals based on machine learning utilizing components of the system 100 is shown by way of example. Referring initially to FIG. 2A, following power up of the host system and the clock system (Start), at operation 202 the one or more processors can perform an initialization. For example, the initialization may include initializing system parameters, loading a pre-trained model into the machine learning processor 112, initializing data structures for the sensor data, timing data, frequency measurements, and control parameters, setting initial operating conditions of a direct digital synthesis (DDS) and/or fractional-N phase locked loop (PLL) to control the output frequency generated by the oscillator 108, and collecting sensor data from the plurality of sensors when available.

At operation 204, the one or more processors (e.g., the system processor 110) can determine whether data is available to be collected, including the sensor data. If the data is unavailable (No), the one or more processors can continue to stand by. If the data is available (Yes), at operation 206 the one or more processors can collect the data, including real time sensor data from the sensors, and store the data in a storage system, such as the memory 114 (e.g., stored as historical sensor data for training). The one or more processors (e.g., the system processor 110 and/or the machine learning processor 112) can also preprocess the sensor data, including to normalize the sensor data, resolve missing values and outliers, and/or aggregate the sensor data into a structured format. The one or more processors can also extract features from the sensor data and/or calculate statistical measures from the sensor data, such as a rate of change, variance, and/or historical trend.

Referring further to FIG. 2B, following collection of the sensor data, at operation 208, the one or more processors (e.g., the system processor 110) can utilize the frequency measurement unit 118 to calculate frequency drifts or errors (F_{ERROR}), e.g., determined between an output frequency of the clock signal (F_{OUT}) and the reference frequency (F_{REF}). The one or more processors can store the frequency drifts or errors in the storage system, such as the memory 114 (e.g., stored as historical frequency error data for training). For example, the one or more processors can utilize the frequency measurement unit 118 to measure a current output frequency of the oscillator 108 and compare that against the reference timing signal, including in some cases a frequency division based on the output frequency. Thus, the one or more processors can also utilize the frequency measurement unit 118 to calculate the frequency error (e.g., F_{ERROR}=F_{OUT}−F_{REF}) and store current sensor data corresponding to the frequency error in the storage system.

At operation 210, the one or more processors (e.g., the machine learning processor 112) can execute instructions stored in memory to train a machine learning model, during a training period, to predict frequency drift (F_{ERROR} or F_{DRIFT}) of the clock signal (F_{OUT}). The one or more processors can train the machine learning model based on a combination of the sensor data and the frequency drifts or errors (e.g., in the storage system, such as the memory 114). In particular, the sensor data may be utilized as training data to train the machine learning model and the frequency drifts or errors may be utilized as target data representing a correct output that the machine learning model should predict during the training period. For example, the machine learning model may be trained to predict frequency drift by predicting coefficients of one or more polynomials characterizing a relationship between the output frequency of the clock signal and the sensor data. The machine learning model may, for example, be or include one or more of a neural network (e.g., a convolutional neural network, recurrent neural network, deep neural network, or other neural network), decision tree, vector machine, Bayesian network, cluster-based system, genetic algorithm, deep learning system separate from a neural network, or other model.

In some implementations, the machine learning model may be a pre-trained model (e.g., a pre-trained neural network model), e.g., from a server, which is fine-tuned based on training utilizing the sensor data and the frequency drifts or errors (F_{ERROR}). For example, the pre-trained model may be trained based on past sensor data from other sensors and systems under varied conditions to predict frequency drifts (F_{DRIFT}). The pre-trained model may then be fine-tuned based on training utilizing the sensor data and the frequency drifts or errors in situ with the host system (e.g., the model can continuously update with new sensor data in the system in which it is deployed, directly on the device). This enables real time, on-device ML processing, to reduce latency and improve response times in dynamic environments. In some cases, at operation 210, the one or more processors can update the pre-trained model (e.g., received via a downloadable update), and the fine-tuning associated with the training may repeat as described herein.

Next, the one or more processors (e.g., the machine learning processor 112) can execute instructions stored in memory to adjust the clock signal, during a deployment period, to compensate for frequency drift based on a prediction from the machine learning model. For example, the clock signal can be adjusted based on the prediction from the machine learning model when the reference timing signal is unavailable from the timing system 102, such as in a lower power mode controlled by the PMU 122, or during a network connection loss to the GNSS, cellular network, or Ethernet network. In particular, at operation 212 the one or more processors can utilize the machine learning model to predict a frequency drift of the clock signal (F_{OUT}) in real time with collection of the sensor data. Then, at operation 214 the one or more processors can generate a tuning output (F_{TUNE}), based on the prediction, targeted to correct the frequency drift. The tuning output may be transmitted to the oscillator 108. Further, the tuning output (F_{TU}NE) may be stored in the data structure 116, with the sensor data and F_{ERROR} measurements, for training the machine learning model. For example, this stored data can be used in subsequent training cycles of the model, enabling continuous model refinement and improved prediction accuracy over time.

In some implementations, DDS, and/or fractional-N PLL may be utilized to provide fine-grained control of the output frequency generated by the oscillator 108. This may enable adjusting the output frequency of the oscillator 108, based on predictions from the machine learning model, utilizing DDS and/or Frac-N PLL control parameters (e.g., transmitted from the one or more processors to the oscillator 108). In some cases, corrections to the clock frequency, based on predictions, may be applied by adjusting a divider ratio of the PLL. The oscillator 108, in turn, can generate a frequency drift compensated clock output (F_{OUT}_N) that may be transmitted to the filter 120. Then, at operation 216, the system 100 can apply the filter 120 to remove noise/transients and generate the clock signal (F_{OUT}) with the frequency drift compensated adjustment. In a closed loop of the system 100, the clock signal (F_{OUT}) can also provide feedback to the frequency measurement unit 118 to calculate a next frequency error at operation 208. This may enable a next prediction in a repeating fashion for correction through multiple cycles of the clock signal, and while continuously updating the system based on new data.

As a result, the system 100 can utilize machine learning to mitigate one or more limitations of traditional timing devices, such as by correcting long term aging behavior and/or compensating for environmental conditions. The system 100 can therefore maintain high precision and reliability over relatively longer periods (as compared to traditional timing devices), adapt to environmental changes, and/or operate more efficiently in power-sensitive applications (e.g., mobile devices and IoT devices, such as wearable devices).

In some implementations, the machine learning model can be updated periodically during the deployment period based on new data. For example, the one or more processors (e.g., the machine learning processor 112) can incrementally update the machine learning model (stored in the data structure 116) in real time based on updates of the sensor data and/or frequency drifts or errors. For example, the one or more processors can use stochastic gradient descent (SGD), mini-batch gradient descent, or another algorithm which could perform to update weights of the model for the update.

In some implementations, the system 100 can enhance location accuracy. For example, in mobile devices (e.g., smartphones), the system 100 can improve location services, navigation, and/or user experience. In some implementations, the system 100 can reduce power consumption. For example, for mobile devices and IoT devices, the clock signal, corrected to improve stability, can enable less frequent synchronizations with the timing system 102 (e.g., a GNSS signal), thereby allowing the timing system 102 to enter a low power mode for a longer period. In another example, the clock signal, corrected to improve stability, can reduce the pre-wake-up time utilized in a communication protocol such as Bluetooth. In some implementations, the system 100 can improve network performance. For example, the system 100 can provide improved timing synchronization to enhance network communications, reduce latency, and increase service quality. In some implementations, the system 100 can increase reliability of the host system. For example, the system 100 can utilize the clock signal, corrected for drift, to maintain precise timing over a longer period without frequent recalibration. In some implementations, the system 100 can improve holdover performance in conditions in which location services are unavailable. For example, in GPS-denied environments, or in situations where spoofing is suspected, the system 100 can maintain continuous, accurate timing by leveraging the machine learning corrections.

In some implementations, the system 100 can utilize additional data to perform the training. For example, the system 100 can utilize Wi-Fi, Bluetooth, and/or cellular network data to obtain more feedback about the environment and correspondence to frequency drifts or errors. In some implementations, the system 100 can utilize deep learning or reinforcement learning for the machine learning model to perform the predictions. In some implementations, the system 100 can utilize continuous learning in which the machine learning model periodically self-updates based on new data. In some implementations, the system 100 can further utilize the same or another machine learning model to reduce power consumption associated with the machine learning processing. The system 100 can implement adaptive power management in which utilization of the machine learning processing (e.g., the machine learning processor 112), and associated with processing power, scales based on current precision requirements (e.g., a high power mode vs. a low power mode). In some implementations, the system 100 can utilize a modular architecture of the clock system to enable integration with different host systems. This may enable, for example, compatibility with multiple GNSS systems (e.g., GPS, GLONASS, Galileo, BeiDou). In some implementations, the system 100 can utilize error correction and/or redundancy to enable the system 100 to continue with reliability in the presence of sensor and/or data anomalies. This may enable the system 100 to be robust against a wide range of environmental conditions, such as extreme temperatures, humidity, and physical shocks.

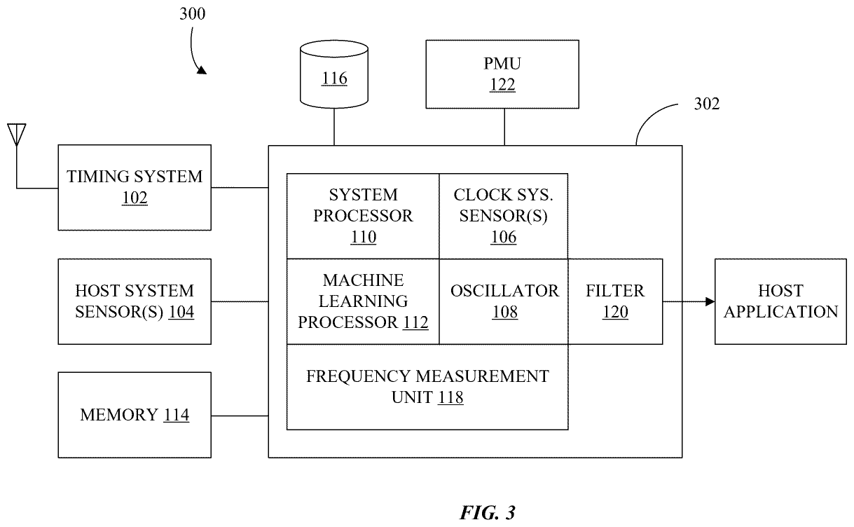

The system 100 advantageously enables a modular architecture for adjusting clock signals based on machine learning. With additional reference to FIG. 3, a first example of adjusting a clock signal in a host system 300 is shown by way of example. The host system 300 could be a mobile device, navigation system, telecommunication system, wearable device, automotive system, or other electronic equipment. The host system 300 can implement and include a clock system 302 to generate a clock signal that an application of the host system 300 can utilize. The host system 300 may include components of the system 100 of FIG. 1, including some components implemented by the clock system 302, and other components implemented outside of clock system 302 (e.g., native to the host system 300). For example, the host system 300 can include the clock system sensors 106, the oscillator 108, the system processor 110, the machine learning processor 112, the frequency measurement unit 118, and the filter 120, implemented by the clock system 302. Additionally, the host system 300 can natively include the timing system 102, the host system sensors 104, the memory 114, the data structure 116, and/or the PMU 122, which the clock system 302 can efficiently utilize.

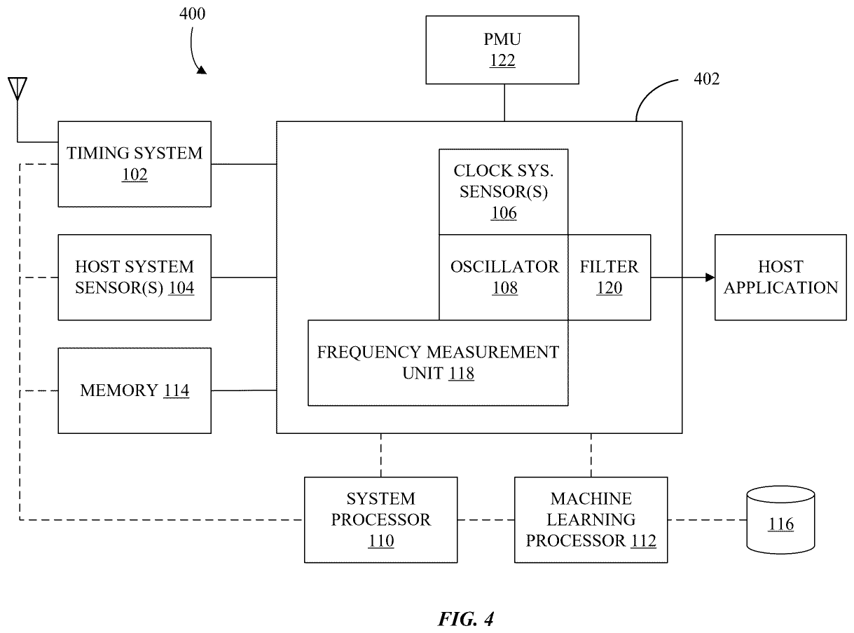

FIG. 4 is a second example of adjusting a clock signal in a host system 400. The host system 400 could be a mobile device, navigation system, telecommunication system, wearable device, automotive system, or other electronic equipment. The host system 400 can include a clock system 402 to generate a clock signal that an application of the host system 400 can utilize. The host system 400 may include components of the system 100 of FIG. 1, including some components implemented by the clock system 402, and other components implemented outside of clock system 402 (e.g., native to the host system 400). For example, the host system 400 may include some components implemented by the clock system 402, and other components implemented outside of clock system 402 (e.g., native to the host system 400). For example, the host system 400 can include the clock system sensors 106, the oscillator 108, the frequency measurement unit 118, and the filter 120, implemented by the clock system 402. Additionally, the host system 400 can natively include the timing system 102, the host system sensors 104, the system processor 110, the machine learning processor 112, the memory 114, the data structure 116, and/or the PMU 122, which the clock system 402 can efficiently utilize.

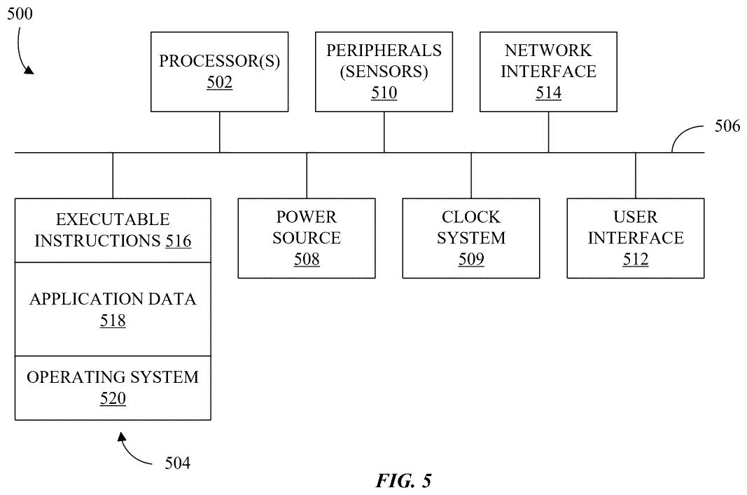

FIG. 5 is a block diagram of an example internal configuration of a host system 500 that adjusts clock signals based on machine learning. In various configurations, the host system 500 may comprise a computer or other apparatus that implements components of the system 100 of FIG. 1.

The host system 500 includes components or units, such as a processor 502, a memory 504, a bus 506, a power source 508, a clock system 509, peripherals 510, a user interface 512, a network interface 514, other suitable components, or a combination thereof. One or more of the memory 504, the power source 508, the peripherals 510, the user interface 512, or the network interface 514 can communicate with the processor 502 via the bus 506.

The processor 502 may include a central processing unit, such as a microprocessor, and can include single or multiple processors having single or multiple processing cores, such as the system processor 110 and/or the machine learning processor 112. Alternatively, the processor 502 can include another type of device, or multiple devices, configured for manipulating or processing information. For example, the processor 502 can include multiple processors interconnected in one or more manners, including hardwired or networked. The operations of the processor 502 can be distributed across multiple devices or units that can be coupled directly or across a local area or other suitable type of network. The processor 502 can include a cache, or cache memory, for local storage of operating data or instructions.

The memory 504 includes one or more memory components, which may each be volatile memory or non-volatile memory, such as the memory 114 and/or the data structure 116. For example, the volatile memory can be random access memory (RAM) (e.g., a DRAM module, such as dual data rate (DDR) DRAM). In another example, the non-volatile memory of the memory 504 can be a disk drive, a solid state drive, flash memory, or phase-change memory. In some implementations, the memory 504 can be distributed across multiple devices. For example, the memory 504 can include network-based memory or memory in multiple clients or servers performing the operations of those multiple devices.

The memory 504 can include data for immediate access by the processor 502. For example, the memory 504 can include executable instructions 516, application data 518, and an operating system 520. The executable instructions 516 can include one or more application programs, which can be loaded or copied, in whole or in part, from non-volatile memory to volatile memory to be executed by the processor 502. For example, the executable instructions 516 can include instructions for performing some or all of the techniques of this disclosure, including training a machine learning model to predict frequency drift (F_{DRIFT}), and adjusting a clock signal (F_{OUT}) to compensate for frequency drift based on a prediction from the machine learning model. The application data 518 can include user data, database data (e.g., database catalogs or dictionaries), or the like. In some implementations, the application data 518 can include functional programs, such as a web browser, a web server, a database server, another program, or a combination thereof. The operating system 520 can be, for example, any known personal or enterprise operating system; an operating system for a mobile device, such as a smartphone, laptop, or tablet device; or an operating system for a non-mobile device, such as a mainframe computer.

The power source 508 provides power to the host system 500. For example, the power source 508 can be an interface to an external power distribution system, such as the PMU 122. In another example, the power source 508 can be a battery, such as where the host system 500 is a mobile device or is otherwise configured to operate independently of an external power distribution system. In some implementations, the host system 500 may include or otherwise use multiple power sources. In some such implementations, the power source 508 can be a backup battery.

The clock system 509 provides one or more clock signals to the host system 500. For example, the clock system 509 can implement components of the system 100. In some implementations, the clock system 509 may utilize a quartz oscillator or a silicon oscillator (e.g., either one potentially including an integrated temperature sensor), such as the dual mode MEMS resonator 109 of the oscillator 108. The clock system 509 may include one or more clock system sensors, such as the clock system sensors 106.

The peripherals 510 includes one or more sensors, detectors, or other devices configured for monitoring the host system 500, the clock system 509, or the environment around the host system 500 or the clock system 509. The peripherals can include a sensor for sensing and measuring temperature, humidity, acceleration, rotation, vibration, strain, pressure, or magnetic field of components of the host system 500. For example, the peripherals 510 may include one or more host system sensors, such as the host system sensors 104. In another example, the peripherals 510 can include a geolocation component (e.g., a global positioning system location unit) associated with the timing system 102.

The user interface 512 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 514 provides a connection or link to a network. The network interface 514 can be a wired network interface or a wireless network interface. The host system 500 can communicate with other devices via the network interface 514 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the network interface 514 may include circuitry for the timing system 102 to provide a connection or link to a GNSS, a cellular network, or an Ethernet network to receive the reference timing signal.

Reference is now made to flowcharts of examples of processes that adjust clock signals based on machine learning. The processes can be executed using computing devices, such as the systems, hardware, and software described with respect to FIGS. 1-5. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

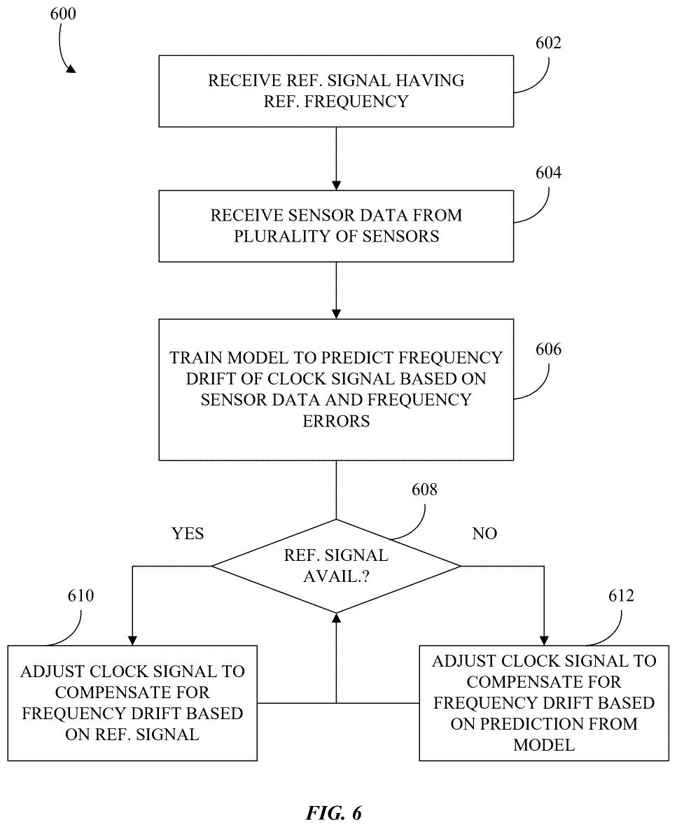

FIG. 6 is an example of a process 600 for adjusting clock signals based on machine learning. At operation 602, a system can receive a reference timing signal having a reference frequency. For example, the system 100 can receive, via the timing system 102, the reference timing signal having the reference frequency (F_{REF}).

At operation 604, the system can receive sensor data from a plurality of sensors. For example, the system 100, via the system processor 110, can receive sensor data from multiple sensors, such as one or more of the host system sensors 104, and/or one or more of the clock system sensors 106.

At operation 606, the system can train a machine learning model, during a training period, to predict frequency drift of a clock signal based on the sensor data and frequency drifts or errors between an output frequency of the clock signal and the reference frequency. For example, this may include adjusting the output frequency to match the reference frequency (e.g., frequency division of the output frequency to scale the output frequency to the reference frequency). The sensor data may be utilized as training data to train the machine learning model, and the frequency drifts or errors may be utilized as target data representing a correct output that the machine learning model should predict, during the training period. For example, the machine learning processor 112 can train the machine learning model, during the training period, to predict frequency drift (F_{DRIFT}) of the clock signal (F_{OUT}). The machine learning model may be trained to predict the frequency drift by predicting coefficients of one or more polynomials characterizing relationships between the output frequency of the clock signal and the sensor data.

Meanwhile, the system can utilize the reference timing signal to compensate for frequency drift during the training period (e.g., based on frequency drifts or errors between the output frequency of the clock signal and the reference frequency). Thus, the machine learning model may be trained when the reference timing signal is available, including while the reference timing signal is being utilized to compensate for frequency drift. In some implementations, the machine learning model may be a pre-trained model that is fine-tuned based on training utilizing the sensor data and the frequency drifts or errors.

At operation 608, during a deployment period, the system can determine whether the reference timing signal is available. If the reference timing signal is available (Yes), at operation 610 the system can adjust the clock signal to compensate for frequency drift based on the reference timing signal. In particular, the system can continue to utilize the reference timing signal to adjust the clock signal and maintain a reliable clock for the host system while the reference timing signal continues to be available. In some cases, the system can also continue to store frequency drifts or errors for future training. The system can then return to operation 608 to determine a next path for ongoing correction.

However, if the reference timing signal is unavailable (No), at operation 612 the system can adjust the clock signal to compensate for frequency drift based on a prediction of the frequency drift (F_{DRIFT}) from the machine learning model. In particular, the system can utilize a machine learning model to generate predictions to adjust the clock signal and maintain a reliable clock for the host system in the absence of the reference timing signal. The system can again return to operation 608 to determine a next path for ongoing correction.

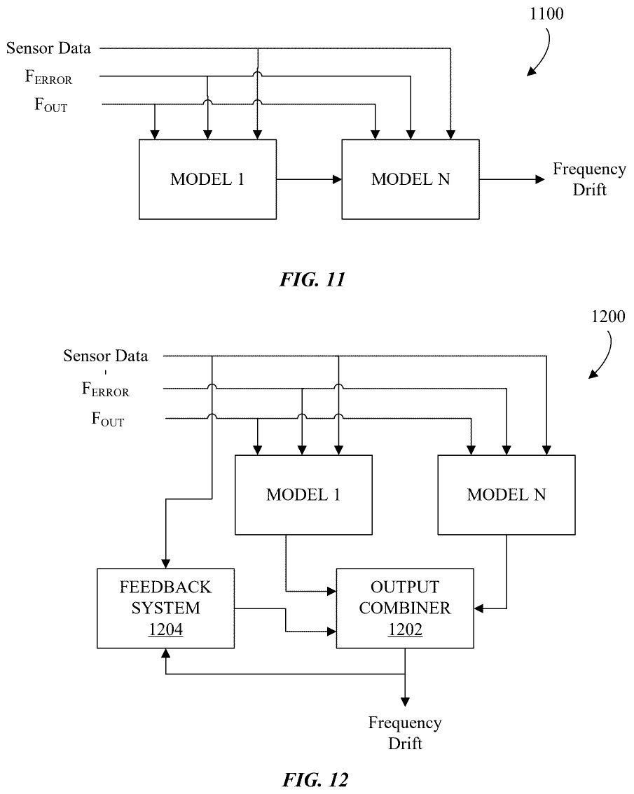

FIG. 11 is an example of a machine learning model 1100 to adjust clock signals. The machine learning model 1100 is shown utilizing serial modeling by way of example (e.g., a chain of models feeding sequentially into each other). The machine learning model 1100 may be utilized by the machine learning processor 112 and/or stored in the data structure 116 of FIG. 1. Further, the machine learning model 1100 may be the model trained at operation 210 of FIG. 2B. The machine learning model 1100 may include one or models, such as model 1 to model N where N is an integer greater than one. The models may be coupled to one another in a feed forward arrangement so that the output of one model may be propagated to a next or subsequent model. The models may be trained differently from one another so that a later model (e.g., model N) may modify the output of an earlier model (e.g., model 1). The first model, model 1, may receive sensor data from the plurality of sensors, frequency drifts of the clock signal (e.g., F_{ERROR}, from the frequency measurement unit 118), and/or the clock signal (e.g., Four) from the oscillator 108, via the filter 120. The first model may be trained to predict a frequency drift of the clock signal (e.g., to generate F_{TUNE}) by utilizing the sensor data as training data, and the frequency drifts as target data, during a training period.

In some cases, once trained, the first model, model 1, may generate an early prediction of a frequency drift of the clock signal. Then, a next or subsequent model, e.g., model N, may modify the early prediction of an earlier model, e.g., model 1, to generate a later prediction of the clock signal, until a final prediction is generated by a final model in the chain. The final prediction may be used to adjust the clock signal. The next or subsequent models, e.g., model N, may receive sensor data from the plurality of sensors, and an output from an earlier model, e.g., an early prediction. The next or subsequent models may be trained to predict a frequency drift of the clock signal by utilizing the sensor data as training data during the training period.

In some cases, one or more of the models may be time series models, e.g., a statistical model that analyzes data points collected over time, such as the sensor data, the frequency drifts, etc., to identify patterns and trends to enable predictions of future frequency drifts. In some cases, one or more of the models may be a hybrid and/or physics-aware prediction model that combines an analytical model with a neural network to improve resilience to environmental variations that may challenge a pure neural network model. The analytical model may be a simplified, mathematical representation of a real-world system or phenomenon, used to characterize and predict frequency drifts based on environmental conditions, e.g., temperature, humidity, acceleration, rotation, vibration, strain, pressure, and/or magnetic field. For example, the analytical model may comprise a logical implementation of one or more equations. In some cases, one or more models, e.g., model 1, implemented by a physics-aware analytical model, can characterize and predict based on short term aging of the system based on short term environmental conditions captured via the sensor data, e.g., less than 24 hours, such as the last few hours, while one or more other models, e.g., model N, implemented by a neural network, can characterize and predict based on long term aging of the system based on long term environmental conditions captured via the sensor data, e.g., greater than 24 hours, such as multiple weeks, months, or years. Further, one or more of the models may utilize a non-volatile circular buffer or ring buffer (a data structure that uses a single, fixed-size buffer as if connected end-to-end.) or equivalent persistent memory, which may be differently configured among the models, e.g., model 1 utilizing a smaller buffer, and model N utilizing a larger buffer. As a result, the models may be combined to characterize and predict based on each of a short term aging of the oscillator 108 and a long term aging of the oscillator 108, and to correct for frequency drifts of the oscillator 108 based on the combination of characterizations.

FIG. 12 is an example of a machine learning model 1200 to adjust clock signals. The machine learning model 1200 is shown utilizing parallel modeling by way of example (e.g., parallel models feeding into an output combiner 1202). The machine learning model 1200 may be utilized by the machine learning processor 112 and/or stored in the data structure 116 of FIG. 1. Further, the machine learning model 1200 may be the model trained at operation 210 of FIG. 2B. The machine learning model 1200 may include one or models, such as model 1 to model N where N is an integer greater than one. The models may be configured in a parallel to one another so that the output of each model may be sent to a combiner. The models may be trained differently from one another. Each model may receive sensor data from the plurality of sensors, frequency drifts of the clock signal (e.g., F_{ERROR}, from the frequency measurement unit 118), and/or the clock signal (e.g., F_{OUT}) from the oscillator 108, via the filter 120. The models may be trained differently from one another to predict a frequency drift of the clock signal (e.g., to generate F_{TUNE}) by utilizing the sensor data as training data, and the frequency drifts as target data, during a training period. For example, model 1 may be a physics-aware analytical model, to characterize and predict based on short term aging of the system using short term environmental conditions captured via the sensor data, e.g., less than 24 hours. Model N may be by a neural network to characterize and predict based on long term aging of the system using long term environmental conditions captured via the sensor data, e.g., greater than 24 hours. The outputs of the model may be combined by the output combiner 1202, using configurable weights, to predict the frequency drift in a composite output. Further, in some cases, a feedback system 1204 (e.g., state machine logic) may apply corrections to the output combiner 1202 (e.g., adjust weighting of inputs from the models) based on the sensor data and/or the predictions generated by the output combiner 1202 (e.g., adjust weights of the output combiner 1202 based on an elapsed time since a last sync, environmental conditions, etc.).

In some implementations, the system may include one or more additional noise filters at specific positions to reduce analog and/or digital noise and increase accuracy of the predictions. For example, referring again to FIG. 1, the system 100 may include a noise filter 104A to suppress electrical noise at sensor interfaces, e.g., between the host system sensors 104 and the system processor 110, and/or noise filter 108A to suppress electrical noise at a power supply input of the oscillator 108. The noise filters may include, for example, passive discrete elements, such as inductors and capacitors. The noise filters may suppress frequency fluctuations that may accumulate to cause timing errors. The noise filters may be in addition to filtering performed by the power supply and/or the sensors, e.g., in conjunction with a linear dropout (LDO) regulator.

An aspect of the disclosure may include a non-transitory machine-readable medium (such as computer memory) having stored thereon instructions, which program one or more data processing components (generically referred to here as a “processor”) to (automatically) perform operations, as described herein. In other aspects, some of these operations might be performed by specific hardware components that contain hardwired logic. Those operations might alternatively be performed by any combination of programmed data processing components and fixed hardwired circuit components. A “processor” may include a distributed arrangement where multiple processors are configured and controlled to perform the recited operations or tasks together, e.g., one processor can perform some of the recited operations and another processor can perform others of the recited operations.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

In utilizing the various aspects of the embodiments, it would become apparent to one skilled in the art that combinations or variations of the above embodiments are possible for adjusting clock signals based on machine learning. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration. Furthermore, it is to be appreciated that the figures have been provided for illustrational purposes and may not be to scale. Also, in the interest of conciseness and reducing the total numbers of figures, a given figure may be used to illustrate the features of more than one aspect of the disclosure, and not all elements in the figure may be required for a given aspect.

What is claimed is:

1. A system for adjusting a clock signal, comprising:
a timing system to receive a reference timing signal;
a plurality of sensors to generate sensor data;
an oscillator to generate a clock signal; and
one or more processors to:
train a machine learning model, during a training period, to predict frequency drift of the clock signal based on sensor data from the plurality of sensors and frequency drifts of the clock signal determined based on the reference timing signal, wherein the sensor data is utilized as training data to train the machine learning model, and the frequency drifts are utilized as target data representing a correct output to predict; and
adjust the clock signal, during a deployment period, to compensate for a frequency drift based on a prediction from the machine learning model when the reference timing signal is unavailable.

2. The system of claim 1, wherein the machine learning model comprises a first model and a second model, the first model to predict based on short term aging, and the second model to predict based on long term aging.

3. The system of claim 1, wherein the machine learning model comprises a pre-trained model that is fine-tuned based on the training utilizing the sensor data during the training period.

4. The system of claim 1, wherein the machine learning model is trained to predict the frequency drift by predicting coefficients of one or more polynomials characterizing a relationship between an output frequency of the clock signal and the sensor data.

5. The system of claim 1, wherein the plurality of sensors includes a sensor that collects sensor data indicating a transient condition exceeding a threshold.

6. The system of claim 1, wherein the plurality of sensors includes a first sensor that provides more frequent sampling and a second sensor that provides less frequent sampling.

7. The system of claim 1, wherein the sensor data includes data from a sensed temperature and one or more of humidity, acceleration, rotation, vibration, strain, pressure, or magnetic field.

8. The system of claim 1, wherein the oscillator utilizes a first resonant element to generate the clock signal, and wherein the plurality of sensors includes a sensor that characterizes a second resonant element adjacent to the first resonant element.

9. The system of claim 1, wherein the oscillator includes a dual mode microelectromechanical system (MEMS) resonator that operates concurrently in an in-plane mode of vibration and an out-of-plane mode of vibration to produce two electrical signals, including the clock signal.

10. The system of claim 9, wherein the two electrical signals are mixed to determine a temperature to include in the sensor data.

11. The system of claim 1, wherein the oscillator is implemented by an application-specific integrated circuit (ASIC) that provides a feedback loop to generate the clock signal, and wherein the plurality of sensors includes a sensor that is onboard the ASIC.

12. The system of claim 11, wherein the plurality of sensors includes a sensor of a mobile device, wherein the mobile device receives the reference timing signal and utilizes the clock signal.

13. The system of claim 11, wherein the machine learning model comprises an analytical model coupled to a neural network.

14. The system of claim 13, wherein the timing system receives a plurality of reference timing signals, each having a different reference frequency.

15. A method for adjusting a clock signal, comprising:
receiving a reference timing signal;
receiving sensor data from a plurality of sensors;
training a machine learning model, during a training period, to predict frequency drift of a clock signal based on sensor data from the plurality of sensors and frequency drifts of the clock signal determined based on the reference timing signal, wherein the sensor data is utilized as training data to train the machine learning model, and the frequency drifts are utilized as target data representing a correct output to predict; and
adjusting the clock signal, during a deployment period, to compensate for a frequency drift based on a prediction from the machine learning model when the reference timing signal is unavailable.

16. The method of claim 15, further comprising:
selecting the reference timing signal from a plurality of systems that includes a global navigation satellite system (GNSS), a cellular network, and an Ethernet network.

17. The method of claim 15, wherein the machine learning model is trained when the reference timing signal is available and generates predictions to adjust the clock signal when the reference timing signal is unavailable.

18. The method of claim 15, wherein the machine learning model is a pre-trained model from a server.

19. The method of claim 15, wherein the machine learning model predicts the frequency drift by predicting coefficients of one or more polynomials characterizing a relationship between an output frequency of the clock signal and the sensor data.

20. The method of claim 15, wherein the sensor data is collected from a sensor of the plurality of sensors indicating a voltage spike on a power supply line.
